(19) United States
(12) Patent Application Publication
(10) Pub. No.: US 2013/0097852 A1
(43) Pub. Date: Apr. 25, 2013

(54) METHOD OF MANUFACTURING STATOR OF ROTATING ELECTRICAL MACHINE

(71) Applicants: Kentaro Haruno, Toyota-shi (JP); Isao Kato, Toyoake-shi (JP)

(72) Inventors: Kentaro Haruno, Toyota-shi (JP); Isao Kato, Toyoake-shi (JP)

(21) Appl. No.: 13/657,191

(22) Filed: Oct. 22, 2012

(30) Foreign Application Priority Data
Oct. 21, 2011 (JP) 2011-231582

(51) Int. Cl. H02K 15/02

(52) U.S. Cl. 29/596

(57) ABSTRACT

A method of manufacturing a stator of a rotating electrical machine includes: winding coils of a plurality of phases respectively around corresponding teeth; fixing the coils by supplying direct currents to the coils such that Lorentz forces are generated toward a radially outer side of the stator; and connecting neutral points of the coils to one another.

### INCORPORATION BY REFERENCE

The disclosure of Japanese Patent Application No. 2011-231582 filed on Oct. 21, 2011 including the specification, drawings and abstract is incorporated herein by reference in its entirety.

### BACKGROUND OF THE INVENTION

1. Field of the Invention

The invention relates to a method of manufacturing a stator of a rotating electrical machine.

2. Description of Related Art

When a rotating electrical machine is manufactured, a coil formed by bending a flat wire is wound around each tooth of a stator. At this time, the coil is assembled to an outer side of an insulator provided between a corresponding one of the teeth of the stator and the coil, and a clearance is provided between each coil and the insulator. Therefore, the coil may freely move in each slot of the rotating electrical machine.

As a technique related to the invention, for example, Japanese Patent Application Publication No. 2005-110493 (JP 2005-110493 A) describes a heat treatment method for a winding coil of a rotating electrical, machine in the process of impregnating the winding coil of the rotating electrical machine with varnish and curing the varnish. Here, the winding coil is heated by directly supplying high-frequency electric power, having a high frequency than a commercial power supply, to the winding coil, with the use of both induction heating and self-heating from the inside of the winding coil.

Incidentally, when the coil moves within the slot and gets close to the radially inner side of a stator, a distance between the coil and a rotor reduces. Thus, a magnetic flux that passes from the rotor through the coil increases, and a copper eddy loss may increase. In addition, when adjacent coils get close to the radially inner side of the stator, it may be impossible to sufficiently ensure an insulating distance between different coil phases.

### SUMMARY OF THE INVENTION

The invention provides a method of manufacturing a stator of a rotating electrical machine, in which coils are fixed in a state where the coils are brought close to a radially outer side of the stator.

Art aspect of the invention provides a method of manufacturing a stator of a rotating electrical machine. The method includes: winding coils of a plurality of phases respectively around corresponding teeth; fixing the coils by supplying direct currents to the coils such that Lorentz forces are generated toward a radially outer side of the stator; and connecting neutral points of the coils to one another.

In addition, in the method according to the aspect of the invention, the direct currents may be respectively set such that the Lorentz forces applied to the coils are uniform.

According to the aspect of the invention, currents are supplied to the coils such that Lorentz forces are applied toward slot bottom directions (the radially outer side of the stator). By so doing, it is possible to fix the coils in a state where the coils are close to the radially outer side of the stator.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that shows a rotating electrical machine according to an embodiment of the invention;

FIG. 2 is a partially cross-sectional view in the case where center portions of teeth in FIG. 1 are sectioned perpendicularly to an axial direction according to the embodiment of the invention;

FIG. 3 is a flowchart that shows the procedure of the method of manufacturing the stator of the rotating electrical machine according to the embodiment of the invention;

FIG. 4 is a schematic view that shows a state where currents are supplied to a U-phase coil, a V-phase coil and a W-phase coil according to the embodiment of the invention; and

FIG. 5 is a view that shows the directions, and the like, of Lorentz forces applied to the U-phase coil, the V-phase coil and the W-phase coil according to the embodiment of the invention.

### DETAILED DESCRIPTION OF EMBODIMENTS

An embodiment of the invention will be described in detail. Hereinafter, in all the drawings, like reference numerals denote similar elements and the overlap description is omitted. In addition, in the description, previously described reference numerals are used as needed.

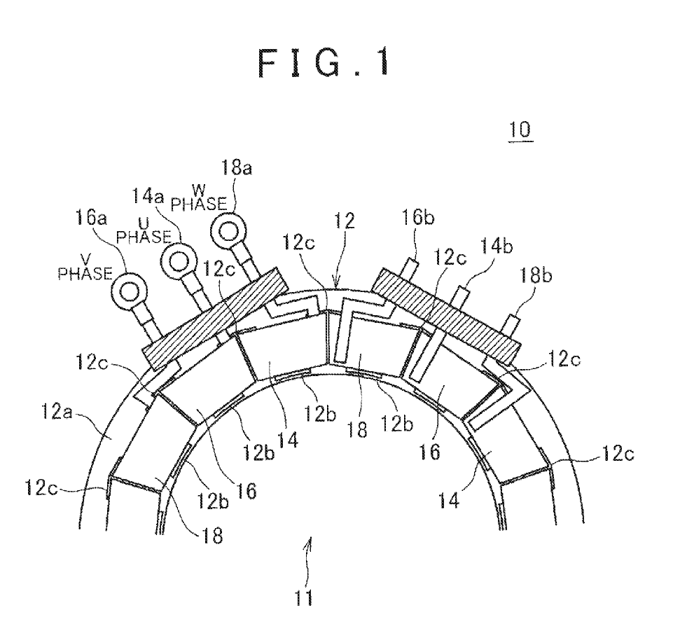

FIG. 1 is a view that shows a rotating electrical machine 10. The rotating electrical machine 10 includes a rotor 11 and a stator 12. The rotating electrical machine 10 is connected to an inverter, wheels of a vehicle, and the like, and functions as an electric motor that drives the wheels as it rotates the rotor 11 by three-phase alternating-current powers from the inverter. In addition, the rotating electrical machine 10 also functions as a generator that generates electric power as it rotates the rotor 11 by rotation of the wheels at the time of regeneration of the vehicle.

In the rotor 11, a plurality of permanent magnets are arranged along the circumferential direction. The rotor 11 rotates by interaction with the stator 12.

The stator 12 includes an annular yoke 12a, a plurality of teeth 12b and a plurality of slots 12c. The plurality of teeth 12b protrude radially inward from the yoke 12a. The plurality of slots 12c are respectively formed between any adjacent teeth 12b. The stator 12 further includes U-phase coils 14, V-phase coils 16 and W-phase coils 18.

The U-phase coils 14, the V-phase coils 16 and the W-phase coils 18 are flat wires respectively wound around the corresponding teeth 12b. The U-phase coils 14, the V-phase coils 16 and the W-phase coils 18 each are formed of a conductive wire having a high electrical conductivity. One-side end portions of the U-phase coils 14 wound around the teeth 12b are electrically connected to one another using a bus bar (not shown), or the like, and are led out to the outside of the stator 12 as a U-phase power line 14a. In addition, the other-side end portions of the U-phase coils 14 wound around the teeth 12b are electrically connected to one another using a bus bar (not shown), or the like, and are led to the outside of the stator 12 as a U-phase neutral line 14b.

As in the case of the U-phase coils 14, one end portions of the V-phase coils 16 are electrically connected to one another using a bus bar, or the like, and are led to the outside of the stator 12 as a V-phase power line 16a, the other end portions of the V-phase coils 16 arc electrically connected to one another using a bus bar, or the like, and are led to the outside of the stator 12 as a V-phase neutral line 16b, one end portions of the W-phase coils 18 are electrically connected to one another using a bus bar, or the like, and are led to the outside of the stator 12 as a W-phase power line 18a and the other end portions of the W-phase coils 18 are electrically connected to one another using a bus bar, or the like, and are led to the outside of the stator 12 as a W-phase neutral line 18b.

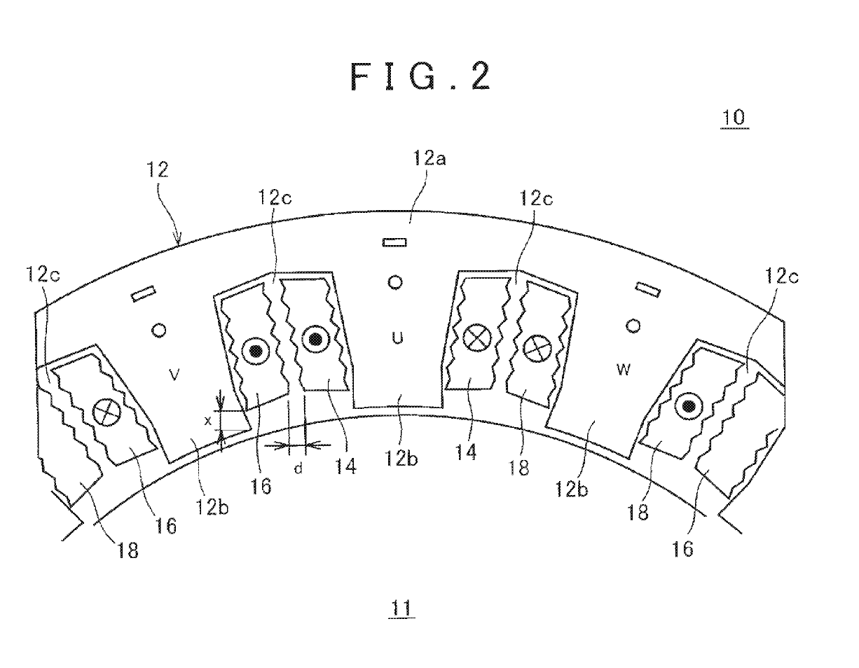

FIG. 2 is a partially cross-sectional view in the case where center portions of the teeth 12b in FIG. 1 are sectioned perpendicularly to an axial direction for the sake of easy illustration of a positional relationship between the teeth 12b and the phase coils (the U-phase coils 14, the V-phase coils 16 and the W-phase coils 18). In the rotating electrical machine 10, between any adjacent coils of the U-phase coils 14, the V-phase coils 16 and the W-phase coils 18, a phase clearance d is formed in order to ensure electrical insulation. As shown in FIG. 2, the clearance d (phase clearance d) is formed between the U-phase coil 14 and the V-phase coil 16. In addition, similarly, the phase clearance d is formed between the U-phase coil 14 and the W-phase coil 18 and between the V-phase coil 16 and the W-phase coil 18.

In the rotating electrical machine 10, as shown in FIG. 2, a clearance x (distal end clearance x) is formed between the V-phase coil 16 and the distal end portion of the corresponding tooth 12b. That is, a distance between the V-phase coil 16 and the rotor 11 is ensured. In addition, similarly, a distal end clearance x is formed between the U-phase coil 14 and the distal end portion of the corresponding tooth 12b, and a distal end clearance x is formed between the W-phase coil 18 and the distal end portion of the corresponding tooth 12b.

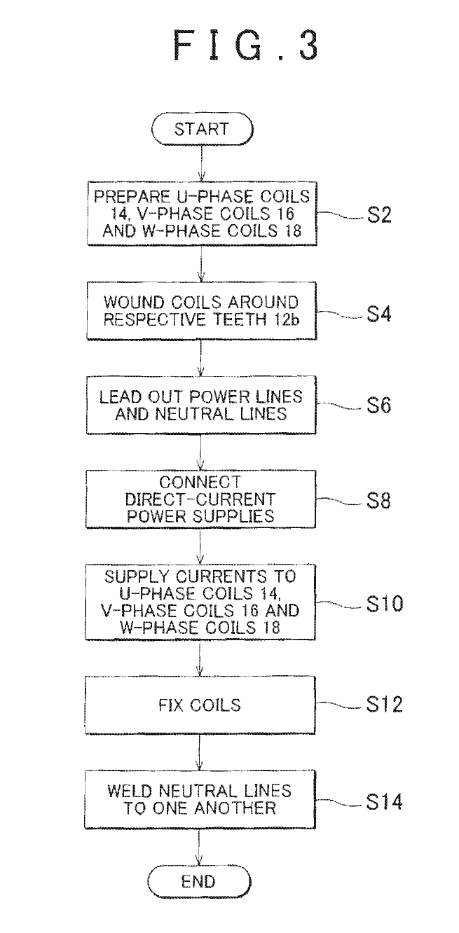

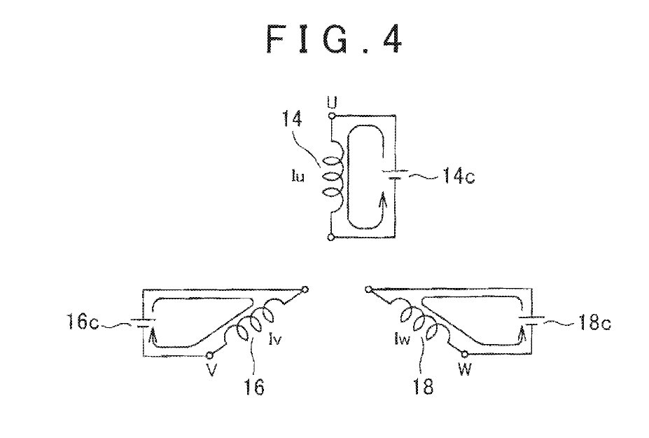

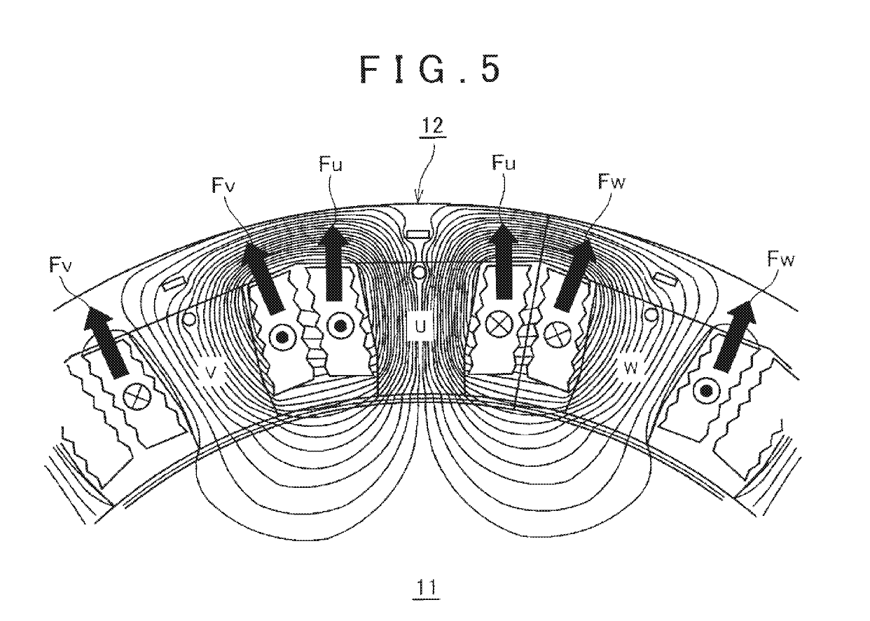

A method of manufacturing the stator 12 of the rotating electrical machine 10 will be described. FIG. 3 is a flowchart that shows the procedure of the method of manufacturing the stator 12 of the rotating electrical machine 10. FIG. 4 is a schematic view that shows a state where currents are supplied to the U-phase coils 14, the V-phase coils 16 and the W-phase coils 18. FIG. 5 is a view that shows the directions, and the like, of Lorentz forces applied to the U-phase coils 14, the V-phase coils 16 and the W-phase coils 18.

First, flat wires are formed to prepare the U-phase coils 14, the V-phase coils 16 and the W-phase coils 18 (S2), and the coils are respectively wound around the corresponding teeth 12b (S4).

Subsequently, one-side end portions and the other-side end portions of the U-phase coils 14 are respectively connected and led out as the U-phase power line 14a and the U-phase neutral line 14b. After that, as in the case of the U-phase coils 14, the V-phase power line 16a, the V-phase neutral line 16b, the W-phase power line 18a and the W-phase neutral line 18b are also led out (86).

A direct-current power supply 14c is connected between the U-phase power line 14a and the U-phase neutral line 14b, a direct-current power supply 16c is connected between the V-phase power line 16a and the V-phase neutral line 16b, and a direct-current power supply 18c is connected between the W-phase power line 18a and the W-phase neutral line 18b (S8). By so doing, as shown in FIG. 4, it is possible to respectively flow different currents Iu, Iv and Iw from the direct-current power supplies 14c. 16c and 18c to the U-phase coils 14, the V-phase coils 16 and the W-phase coils 18.

Next, as shown in FIG. 5, currents are respectively supplied to the coils by the direct-current power supplies 14c, 16c and 18c to generate Lorentz forces Fu, Fv and Fw such that the Lorentz forces Fu, Fv and Fw are applied to the U-phase coils 14, the V-phase coils 16 and the W-phase coils 18 toward bottom directions of the inserted slots 12c (the radially outward direction of the stator 12) (S10). Here, the currents Iu, Iv and Iw respectively supplied from the direct-current power supplies 14c, 16c and 18c are adjusted such that the magnitudes of the Lorentz forces Fu, Fv and Fw respectively applied to the U-phase coils 14, the V-phase coils 16 and the W-phase coils 18 are uniform. Here, a situation that “the magnitudes of the Lorentz forces Fu, Fv and Fw are uniform” does not require the magnitudes of the Lorentz forces Fu, Fv and Fw to be exactly equal to one another. For example, the above situation includes adjusting the currents Iu, Iv and Iw such that variations among Fu, Fv and Fw are smaller than variations among Fu, Fv and Fw (for example, a difference between the maximum Lorentz force and the minimum Lorentz force) that occur in the case where currents having the same magnitude are supplied to the coils. In addition, currents having the same magnitude may be supplied to the coils. Note that, in FIG. 5, lines like contour lines shown on the rotor 11 and the stator 12 indicate magnetic fields generated at the time when currents are supplied to the coils.

Then, the coils are fixed by impregnating the U-phase coils 14, the V-phase coils 16 and the W-phase coils 18 with varnish and thermally curing the varnish (S12). At this time, instead of impregnation with varnish, the coils may be fixed by mold filling and curing.

Finally, after removing the direct-current power supplies 14c, 16c and 18c, the U-phase neutral line 14b, the V-phase neutral line 16b and the W-phase neutral line 18b are connected to one another by welding, or the like, and are subjected to insulating treatment (S14). By so doing, the neutral points of the U-phase coils 14, the V-phase coils 16 and the W-phase coils 18 are connected to one another.

Subsequently, the operation of the method of manufacturing the stator 12 of the rotating electrical machine 10 will he described.

As described above, in the process of S10, magnetic fields are generated by supplying currents to the U-phase coils 14, the V-phase coils 16 and the W-phase coils 18, and Lorentz forces Fu, Fv and Fw that work on the coils radially outward of the stator 12 occur due to interaction between magnetic fluxes, linking with conductors of the coils, and currents.

In the processes of S10 and S12, it is possible to fix the U-phase coils 14, the V-phase coils 16 and the W-phase coils 18 in a state where the coils are close to the radially outer side of the stator 12 by the Lorentz forces Fu, Fv and Fw, that is, in a state where the coils are pressed against the bottom portions of the slots 12c, so the coils do not get close to the radially inner side and the distal end clearances x, and the phase clearances d are ensured. It is possible to reduce a copper eddy loss by sufficiently ensuring the distal end clearances x, that is, the distances between the coils and the rotor 11, to decrease magnetic fluxes passing from the rotor 11 through the coils. In addition, it is possible to sufficiently ensure electrical insulation between any adjacent coils by ensuring the phase clearances d. Note that, by executing the processes of S10 and S12, in the related art, it is not necessary to use resin components, such as coil clamps, used to ensure the distal end clearances x, electrical insulating paper held between any adjacent coils to ensure electrical insulation, or the like. In this case, it is possible to reduce the number of components and reduce cost.

Furthermore, the different direct-current power supplies 14c, 16c and 18c are respectively connected to the U-phase coils 14, the V-phase coils 16 and the W-phase coils 18, so, in the process of S10, it is possible to set appropriate current values respectively for the currents Iu, Iv and Iw on the basis of, for example, installation conditions of the U-phase coils 14, the V-phase coils 16 and the W-phase coils 18.

In addition, in the process of S12, by supplying currents to the coils at the time of impregnating varnish, it is possible to keep the temperature of the preheated stator at a high temperature. Thus, it is possible to appropriately perform heat curing in each treatment.

What is claimed is:

1. A method of manufacturing a stator of a rotating electrical machine, comprising:
winding coils of a plurality of phases respectively around corresponding teeth;
fixing the coils by supplying direct currents to the coils such that Lorentz forces are generated toward a radially outer side of the stator; and
connecting neutral points of the coils to one another.

2. The method according to claim 1, wherein the direct currents are respectively set such that the Lorentz forces applied to the coils are uniform.

3. The method according to claim 2, wherein currents having the same magnitude are supplied to the coils.
